(19) United States
(12) Patent Application Publication
(10) Pub. No.: US 2005/0235575 A1
(43) Pub. Date: Oct. 27, 2005

(54) Abrasive article and manufacturing method thereof

(76) Inventor: Alex Long, Rancho Cucamonga, CA (US)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 11/157,948

(22) Filed: Jun. 22, 2005

Related U.S. Application Data
(62) Division of application No. 10/691,520, filed on Oct. 24, 2003.

(30) Foreign Application Priority Data
Oct. 25, 2002 (TW) 91124928
Dec. 31, 2002 (TW) 91138091

(51) Int. Cl. B24B 1/00; B24D 11/00; C09K 3/14

(52) U.S. Cl. 51/298

(57) ABSTRACT

The present invention relates to a structure and manufacturing method of an abrasive article. In this method, a base layer is first formed to affix abrasive particles on a substrate. Gaps between the abrasive particles are then filled with corrosion-resistant particles and a fixation layer is formed to affix the corrosion particles on the base layer. Further, a binding layer is formed on the base layer. Finally, the substrate, the base layer and the fixation layer are removed to expose the abrasive particles, and the binding layer is the bottom of the abrasive article formed thereby. An abrasive surface formed by the abrasive particles is at about the same level. The binding layer surrounding the abrasive particles form a concave surface and increase adhesion.

### BACKGROUND

1. Field of Invention

The present invention relates to a structure and manufacturing method of an abrasive article. More particularly, the present invention relates to an abrasive article that can be applied in a variety of abrasive tools and can be replaced with ease.

2. Description of Related Art

In the field of applying abrasion facilities and techniques to high precision mold and component processing, the abrasion precision is highly necessary. These abrasive techniques can also be applied in industries that require high precision, such as semiconductor, aerospace and fine ceramics.

An abrasive article in the prior art is shown in FIG. 1. Abrasive particles 14 are affixed on a metal substrate 10 by a plating layer 12. Though the size of abrasive particles 14 is selected before application, size variation still exists. During the plating step, size variation causes the position and level of the abrasive particles 14 to vary, and ultimately results in an uneven distribution of the abrasive particles 14 on the plating layer 12. The uneven distribution decreases the grinding efficiency and effect. Furthermore, since the abrasive particles 14 are plated on the metal substrate 10, a shielding effect occurs due to the geometry of the abrasive particles 14. The shielding effect causes the plating layer 12 surrounding the abrasive particles 14 to form a convex surface and decreases the adhesion between the abrasive particles 14 and the metal substrate 10. Hence, the thickness ratio between the plating layer 12 and the abrasive particles 14 is about 70%, and only about 30% of the abrasive particles 14 can be used. Further, a protective layer 16 is coated on the metal substrate 10 and the abrasive particles 14. During the abrasion process, the protective layer 16 is worn out due to continuous usage, allowing the metal substrate 10 to be damaged, and ultimately the abrasive particles 14 peel off. The situation deteriorates more rapidly if the abrasion is conducted in a corrosive environment and the protective layer 16 is already worn out.

### SUMMARY

One objective of the present invention is to provide a structure and a manufacturing method of an abrasive article that increase the adhesion of the abrasive particles, lower the thickness of the binding layer, and at the same time, increase the duration of abrasive tools.

Another objective of the present invention is to provide a structure and manufacturing method of an abrasive article that results in an even distribution of the abrasive particles, the abrasive surface formed thereby being about level so that the abrasion precision and effect can be increased.

A further objective of the present invention is to provide a structure and manufacturing method of an abrasive article for application to abrasive tools with different shapes and easy replacement.

In accordance with a first preferred embodiment of the present invention, the method of manufacturing an abrasive article comprises the following steps. First, a base layer is formed on a substrate to affix the abrasive particles. A binding layer is then formed on the base layer. Finally, the substrate and the base layer are removed to expose the abrasive particles. Furthermore, after the abrasive particles are affixed on the substrate, a surface roughening treatment can be performed on the abrasive particles to increase the adhesion between the abrasive particles and the binding layer.

In accordance with a second preferred embodiment of the present invention, the method of manufacturing an abrasive article comprises the following steps. First, a base layer is formed to affix the abrasive particles on the substrate. Gaps between the abrasive particles are then filled with corrosion-resistant particles. Further, a fixation layer is formed to affix the corrosion-resistant particles in the gaps and a binding layer is formed on the fixation layer. Finally, the substrate, the base layer and the fixation layer are removed to expose the abrasive particles. Furthermore, after the abrasive particles are affixed on the substrate, a surface roughening treatment can be performed on the abrasive particles and the corrosion-resistant particles to increase the adhesion between the abrasive particles, the corrosion-resistant particles and the binding layer.

In accordance with a third preferred embodiment of the present invention, the method of manufacturing an abrasive article comprises the following steps. First, a first base layer with padding particles is formed on the substrate. The abrasive particles are then placed on the first base layer. A rough surface is formed by the protruded padding particles on the first base layer. By the rough surface of the first base layer, the tips of the abrasive particles may be in contact with the first base layer. A second base layer without padding particles is then formed on the first base layer. Further, a binding layer is formed on the second base layer. Finally, the substrate, the first base layer, along with the padding particles, and the second base layer are removed to expose the abrasive particles. Furthermore, after the abrasive particles are affixed on the first base layer, a surface roughening treatment can be performed on the abrasive particles to increase the adhesion between the abrasive particles and the binding layer.

In accordance with a fourth preferred embodiment of the present invention, the method of manufacturing an abrasive article comprises the following steps. First, a mesh is placed on a substrate and abrasive particles are placed in openings of the mesh. A base layer is formed to affix the abrasive particles on the substrate. Then, gaps between the abrasive particles are filled with corrosion-resistant particles and a fixation layer is formed to affix the corrosion-resistant particles in the gaps. Further, a binding layer is formed on the fixation layer. Finally, the substrate, the base layer, the fixation layer and the mesh are removed to expose the abrasive particles. After the abrasive particles are affixed on the substrate, a surface roughening treatment can be performed on the abrasive particles and the corrosion-resistant particles to increase the adhesion between the abrasive particles, the corrosion-resistant particles and the binding layer.

According to a fifth preferred embodiment of the present invention, an abrasive article structure is provided. The abrasive article comprises a binding layer, abrasive particles affixed on the binding layer, and corrosion-resistant particles filling gaps between the abrasive particles. The binding layer acts as a bottom of the abrasive article, and an abrasion surface formed by the abrasive particles is at about the same level. The binding layer surrounding the abrasive particles forms a concave surface and increases adhesion. Besides, a further protective layer can be formed on the abrasion particles, corrosion-resistant particles, and the binding layer to prevent the binding layer from being corroded by corrosive materials. A rough surface can also be formed on the contact area between the abrasive particles, the corrosion-resistant particles, and the binding layer by the surface roughening treatment.

It is to be understood that both the foregoing general description and the following detailed description are examples, and are intended to provide further explanation of the invention as claimed.

### BRIEF DESCRIPTION OF THE DRAWINGS

These and other features, aspects, and advantages of a preferred embodiment of the present invention will become better understood with regard to the following description, appended claims, and accompanying drawings where:

FIG. 1 is a cross-sectional view of an abrasive article in the prior art;

FIG. 2 is a cross-sectional view that shows the step for forming a base layer to affix abrasive particles on a substrate according to a first preferred embodiment of the present invention;

FIG. 3 is a cross-sectional view that shows the step for forming a binding layer on the fixation layer according to a first preferred embodiment of the present invention;

FIG. 4 is a cross-sectional view that shows the step for removing the base layer and the fixation layer according to a first preferred embodiment of the present invention;

FIG. 5 is a cross-sectional view that shows the step for forming a protective layer on the abrasive particles, the corrosion-resistant particles, and the binding layer according to a first preferred embodiment of the present invention;

FIG. 6 is a cross-sectional view that shows the step for forming a fixation layer to affix corrosion-resistant particles on the base layer according to a second preferred embodiment of the present invention;

FIG. 7 is a cross-sectional view that shows the step for forming the first base layer and the second base layer according to a third embodiment of the present invention;

FIG. 8 is a cross-sectional view that shows the step for placing the abrasive particles in openings of a mesh according to a fourth preferred embodiment of the present invention;

FIG. 9 is a top view of FIG. 8 that shows the step for placing the abrasive particles in openings of a mesh according to a fourth preferred embodiment of the present invention;

FIG. 10 is a cross-sectional view of an abrasive article according to a fifth preferred embodiment of the present invention; and

FIG. 11 is a cross-sectional view that shows an example for applying the abrasive article in a different format according to a preferred embodiment of the present invention.

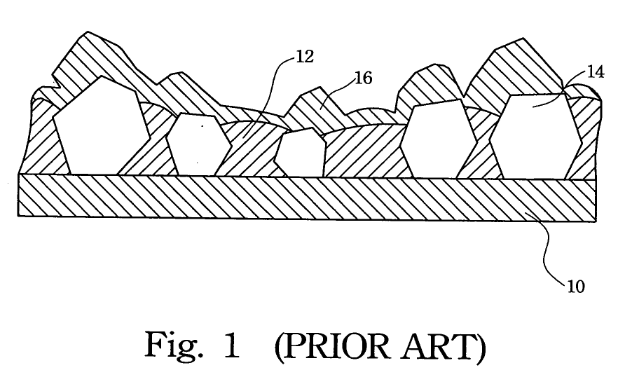

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

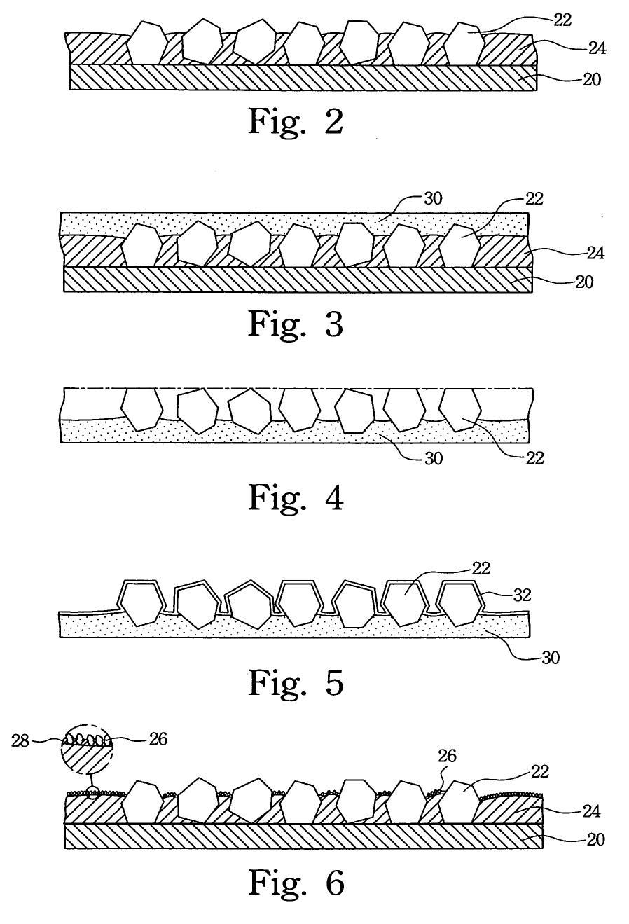

Referring to FIG. 2, according to a first preferred embodiment of the present invention, a base layer 24 is formed to affix abrasive particles 22 on a substrate 20. The abrasive particles 22 are made of a material with abrasive ability such as diamond, boron nitride, aluminum oxide or the like. The base layer 24 is made of a material such as polymer, metal, metal compound or carbide, and is formed by plating techniques, such as electroplating, chemical plating or the like. When the electroplating technique is employed in the step of forming the base layer, the abrasive particles 22 can be placed in the electroplating solution and directly deposited on the substrate 20. Therefore, the manufacturing step can be simplified.

With reference to FIG. 3, a binding layer 30 is formed on the base layer 24 by inorganic plating techniques. In FIG. 4, the substrate 20 and the base layer 24 are then removed by wet etching or grinding with a suitable solvent. The binding layer 30 now is the bottom of the abrasive article according to the first preferred embodiment of the present invention. The base layer 24 or the binding layer 30 may also be formed by sintering or brazing.

The base layer 24 can entirely or partially cover the abrasive particles 22. In the case where the abrasive particles 22 are entirely covered by the base layer 24, an upper portion of the base layer 24 is removed before forming the binding layer 30 on the base layer 24.

Before the step of removing the base layer 24, the binding layer 30 can further react with the abrasive particles 22 to form chemical bonds by heating. The adhesion of the abrasive particles 22 can thus be increased. The binding layer 30 is made of a material being capable of forming chemical bonds with the abrasive particles 22. When the abrasive particles 22 are made of diamond, the binding layer 30 may be made of chromium, cobalt, tungsten, titanium, zinc, iron, manganese, or an alloy thereof. When the abrasive particles 22 are made of boron nitride or aluminum oxide, the binding layer 30 may be made of aluminum, boron, carbon, silicon or the like. The material of the base layer 24 may be iron, nickel, copper, zinc, tin, or an alloy thereof. The material for the base layer 24 may vary, depending upon the requirements of manufacturing process.

Moreover, between the step of forming the base layer and the step of forming the binding layer, a surface roughening treatment can be performed on the abrasive particles 22 to increase the adhesion between the abrasive particles 22 and the base layer 24. The surface roughening treatment may be surface oxidation, surface etching, surface grinding techniques or the like. The abrasion efficiency can therefore be increased.

Referring to FIG. 5, a protective layer may further be formed on the exposed binding layer 30 and the exposed abrasive particles 22 by vapor deposition, spray-on or similar techniques after removing the substrate 20 and the base layer 24. The protective layer may be metal, metal compound, polymer, diamond-like film or the like.

FIG. 6 illustrates a second preferred embodiment of the present invention. After the step of forming the base layer 24 to affix the abrasive particles 22 on the substrate 20 in FIG. 2, gaps between the abrasive particles 22 can further be filled with corrosion-resistant particles 26. Then a fixation layer 28 is formed to affix the corrosion-resistant particles in the gaps. The fixation layer 28 can be made of iron, nickel, copper, zinc, tin or an alloy thereof. The fixation layer 28 can be formed by electroplating, chemical plating or the like. The fixation layer 28 can also be formed by sintering or brazing. A different material can also be employed according to the requirements of the process. Corrosion-resistant particles 26 are acid and base corrosion-resistant and abrasion resistant, and can be made of a material such as diamond, ceramics, polymer, tungsten carbide, boron nitride or the like. The fixation layer 28 is removed by wet etching or grinding after the step of removing the substrate 20 and the base layer 24.

Moreover, between the step of forming the base layer and the step of forming the binding layer, a surface roughening treatment can be performed on the abrasive particles 22 and the corrosion-resistant particles 26 to increase the adhesion between the abrasive particles 22, the corrosion-resistant particles 26 and the base layer 24. The surface roughening treatment may be surface oxidation, surface etching, and surface grinding techniques or the like. The abrasion efficiency can therefore be increased.

Before removing the base layer 24, the binding layer 30 can further react with the abrasive particles 22 and the corrosion-resistant particles 26 to form chemical bonds by heating. The adhesion of the abrasive particles 22 and the corrosion-resistant particles 26 can thus be increased.

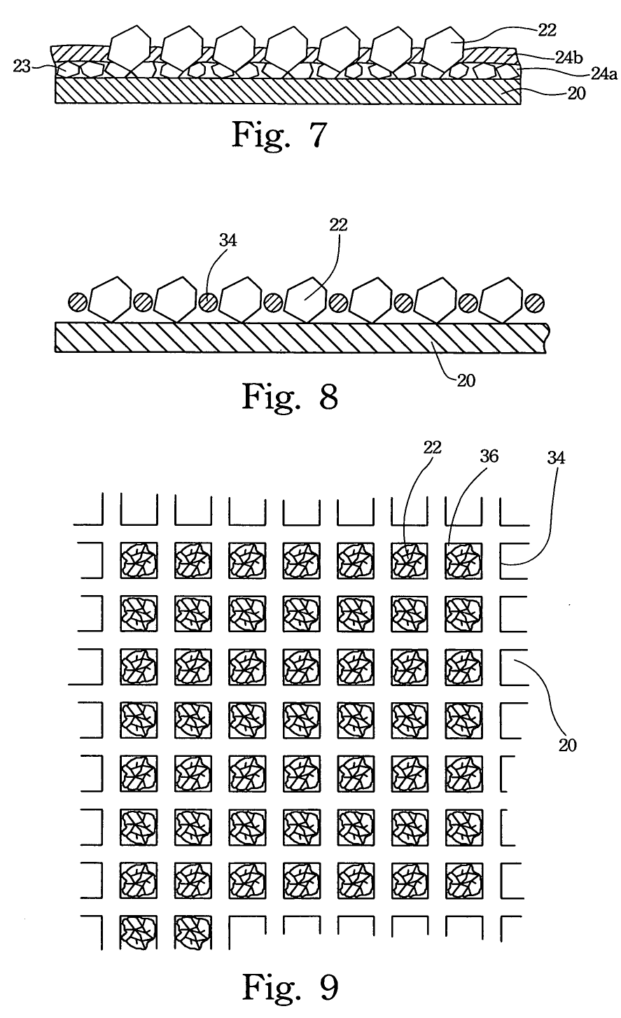

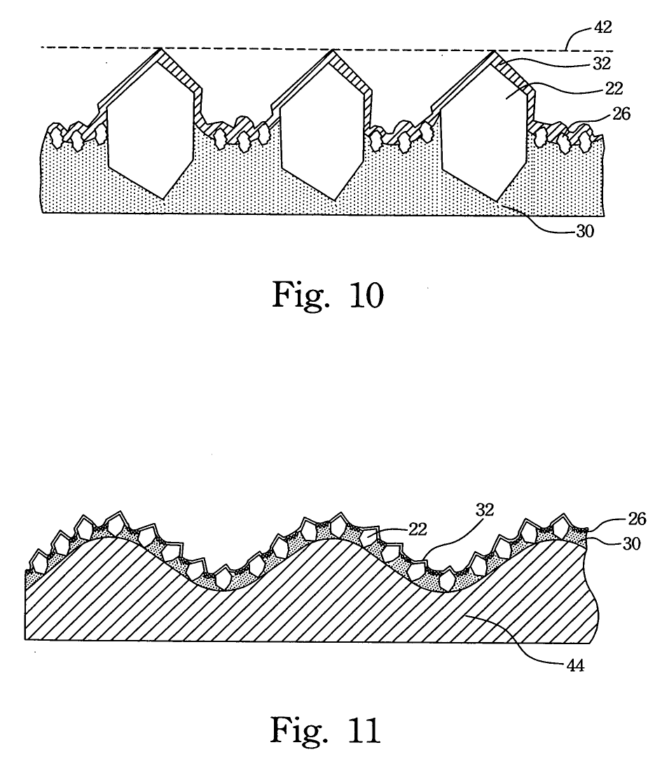

FIG. 7 illustrates a third preferred embodiment of the present invention. The step of forming the base layer can further be divided into two sub-steps. First, a first base layer 24a with padding particles 23 is formed on the substrate. The padding particles 23 may be the same material as the abrasive particles 22, and the size of the padding particles 23 may be smaller than the size of the abrasive particles 22. Plating techniques may be employed to form the first base layer 24a with padding particles 23 by suspending the padding particles 23 in a plating solution. During the plating process, the padding particles 23 are deposited on the substrate along with the first base layer 24a. The abrasive particles 22 are then placed on the first base layer 24a. A rough surface is formed by the protruded padding particles 23 on the first base layer 24a. By the rough surface of the first base layer 24a, the tips of the abrasive particles 22 may be in contact with the first base layer 24a. A second base layer 24b without padding particles is then formed on the first base layer 24a. After forming the binding layer 30, the first base layer 24a and the second base layer 24b are then removed. The padding particles 23 are removed along with the first base layer 24a.

Now referring to FIG. 8 and FIG. 9, a fourth preferred embodiment of the present invention is illustrated. Prior to the step of FIG. 2 described above, a mesh 34 may be placed on the substrate 20. At least one abrasive particle 22 is placed in each opening 36 of the mesh 34. The size and the shape of the opening 36 of the mesh 34 can vary according to the requirements in order to obtain a specific geometric arrangement of the abrasive particles. For example, the size of the opening 36 can be smaller than the size of the abrasive particles 22, so that the abrasive particles 22 can be partially trapped in the opening 36 to allow the tips of the abrasive particles to point down at the substrate. Therefore, abrasive particles 22 with a specific size and orientation can be deposited and distributed evenly on the substrate 20. Besides, in the case where the base layer 24 is formed by electroplating technique, the mesh 34 may be made of a conductive material.

FIG. 11 illustrates one example of applying the abrasive article according to the present invention in an abrasive tool with irregular shape. The abrasive article according to the present invention is attached on a base 44 of an abrasive tool with sinusoidal shape. The abrasive article according to the present invention can also be applied in a variety of abrasion tools such as operation tools for surgery, the abrasion tools utilized by a dentist, or even abrasion tools for semiconductor wafers. The abrasive articles can be applied to different abrasion tools simply by attaching or affixing the abrasive articles on the base of various abrasive tools, and the duration of the abrasive article can be expanded further than that of the prior art.

It will be apparent to those skilled in the art that various modifications and variations can be made to the structure of a preferred embodiment of the present invention without departing from the scope or spirit of the invention. In view of the foregoing, it is intended that a preferred embodiment of the present invention covers modifications and variations of this invention provided they fall within the scope of the following claims and their equivalents.

1-64. (canceled)

65. An abrasive article, comprising:
a binding layer;
abrasive particles affixed on the binding layer; and
corrosion-resistant particles located in gaps between the abrasive particles.

66. The abrasive article of claim 65, wherein an abrasive surface formed by the abrasive particles is at about a same level.

67. The abrasive article of claim 65, wherein when the abrasive particles are made of diamond, the binding layer is made of chromium, cobalt, tungsten, titanium, zinc, iron, manganese or an alloy thereof.

68. The abrasive article of claim 65, wherein when the abrasive particles are made of boron nitride or aluminum oxide, the binding layer is made of aluminum, boron, carbon or silicon.

69. The abrasive article of claim 65, further comprising a protective layer on the binding layer, the abrasive particles and the corrosion-resistant particles.

70. The abrasive article of claim 69, wherein the protective layer is made of metal, metal compound, polymer or a diamond-like material.

71. The abrasive article of claim 65, wherein the abrasive particles and the corrosion-resistant particles have rough surfaces roughen by oxidation, etching or grinding.
